(19) United States
(12) Patent Application Publication
(10) Pub. No.: US 2026/0074574 A1
(43) Pub. Date: Mar. 12, 2026

(54) MOTOR

(71) Applicant: MITSUBA Corporation, Gunma (JP)

(72) Inventor: SHINGO WATANABE, Gunma (JP)

(73) Assignee: MITSUBA Corporation, Gunma (JP)

(21) Appl. No.: 19/302,053

(22) Filed: Aug. 17, 2025

(30) Foreign Application Priority Data
Sep. 12, 2024 (JP) 2024-158342

(51) Int. Cl. H02K 1/18; H02K 7/08; H02K 21/22

(52) U.S. Cl. CPC H02K 1/187; H02K 7/085; H02K 21/22

(57) ABSTRACT

A motor includes a stator including: a cylindrical body including multiple flat surfaces arranged in a circumferential direction so as to surround a shaft, and corner parts located at boundaries of the adjacent flat surfaces; multiple first teeth protruding outward from an outer surface of the cylindrical body and around which coils are wound, and multiple second teeth having a greater number of coil turns than the first teeth; and multiple bolt mounting parts provided on inner surfaces of the corner parts, into which bolts for fixing the stator to a motor bracket are inserted. The flat surfaces are located inside a virtual circle passing through the corner parts at which the bolt mounting parts are provided. The first teeth are formed on outer surfaces of the corner parts at which the bolt mounting parts are provided.

### CROSS-REFERENCE TO RELATED APPLICATION

This application claims the priority benefits of Japanese application no. 2024-158342, filed on Sep. 12, 2024. The entirety of the above-mentioned patent application is hereby incorporated by reference herein and made a part of this specification.

### BACKGROUND

### Technical Field

The disclosure relates to an outer rotor type motor.

### Description of Related Art

In recent years, efforts have been made to promote the Sustainable Development Goals (the 2030 Agenda for Sustainable Development, adopted at the United Nations Summit on Sep. 25, 2015, hereinafter referred to as “SDGs”). Accordingly, technologies that aim to reduce waste and defective products are known in order to ensure sustainable production consumption patterns.

Conventionally, a so-called outer rotor type motor is known that includes a motor bracket, a shaft fixed to the motor bracket, a rotor rotatably supported by the shaft, and a stator fixed to the motor bracket inside the rotor and generating a magnetic field for rotating the rotor (for example, see Patent Literature 1 (Japanese Patent No. 6338172)).

Also, the stator of Patent Literature 1 includes a cylindrical body having a cylindrical shape, multiple bolt mounting parts provided inside the cylindrical body, and multiple teeth protruding radially from the outer peripheral surface of the cylindrical body. A coil that generates a magnetic field for rotating the rotor is wound around each of the teeth.

In the case of attempting to miniaturize such an outer rotor type motor in the radial direction, reducing the protrusion amount of the teeth decreases the number of turns of the coil and reduces motor output. On the other hand, changing the pitch of the bolt mounting holes requires redesigning all components such as the motor bracket from scratch, so it is also difficult to simply reduce the diameter of the cylindrical body to maintain the protrusion amount of the teeth.

The disclosure provides a technology for miniaturizing a motor without reducing motor output.

### SUMMARY

The disclosure provides a motor including a motor bracket, a shaft fixed to the motor bracket, a rotor rotatably supported by the shaft, and a stator fixed to the motor bracket inside the rotor and configured to generate a magnetic field for rotating the rotor. The stator includes: a cylindrical body including multiple flat surfaces arranged in a circumferential direction so as to surround the shaft, and corner parts located at boundaries between the adjacent flat surfaces; multiple first teeth protruding outward from an outer surface of the cylindrical body and having coils wound thereon, and multiple second teeth having a greater number of coil turns than the first teeth; and multiple bolt mounting parts provided on inner surfaces of the corner parts, into which bolts for fixing the stator to the motor bracket are inserted. The flat surfaces are located inside a virtual circle passing through the corner parts at which the bolt mounting parts are provided, the first teeth are formed on outer surfaces of the corner parts at which the bolt mounting parts are provided, and the second teeth are formed on outer surfaces of the flat surfaces on opposite sides of the corner parts at which the bolt mounting parts are provided across the shaft.

### BRIEF DESCRIPTION OF THE DRAWINGS

FIG. 1 is an external perspective view showing a configuration example of a fan device according to an embodiment.

FIG. 2 is an exploded perspective view in the case of disassembling a motor and a fan.

FIG. 3 is an external perspective view of the motor as viewed from the front surface side.

FIG. 4 is a cross-sectional view of a brushless motor taken along IV-IV in FIG. 3.

FIG. 5 is a cross-sectional view of a stator taken along V-V in FIG. 4.

FIG. 6 is a diagram showing the connection state (delta connection) of a coil.

FIG. 7 is a winding development diagram of the stator.

FIG. 8 is a cross-sectional view of a stator according to a modified example.

### DESCRIPTION OF THE EMBODIMENTS

According to the disclosure, a motor can be miniaturized without reducing motor output. Issues, configurations, and effects other than those described above will be clarified by the description of embodiments below.

Hereinafter, as an aspect of a fan device according to an embodiment of the disclosure, a fan device 1 that is mounted on a vehicle such as an automobile and cools engine cooling water flowing through a radiator will be described. However, the application of a motor 2 according to the embodiment is not limited to the fan device 1.

### Overall Configuration of Fan Device 1

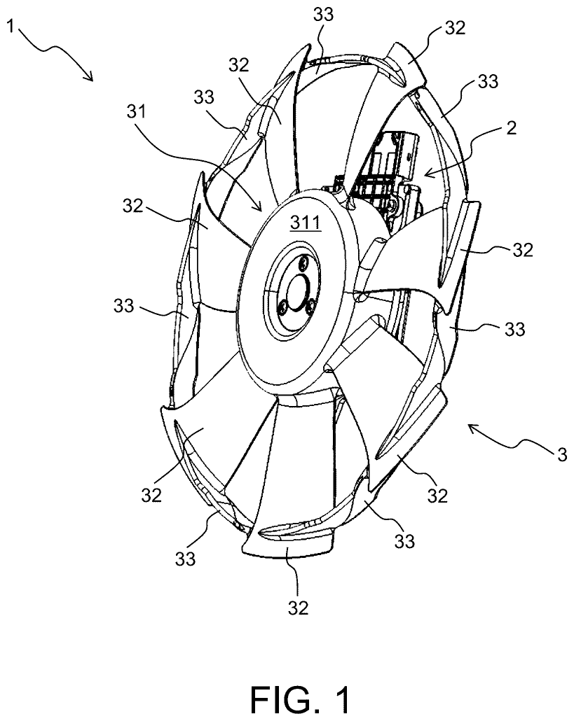

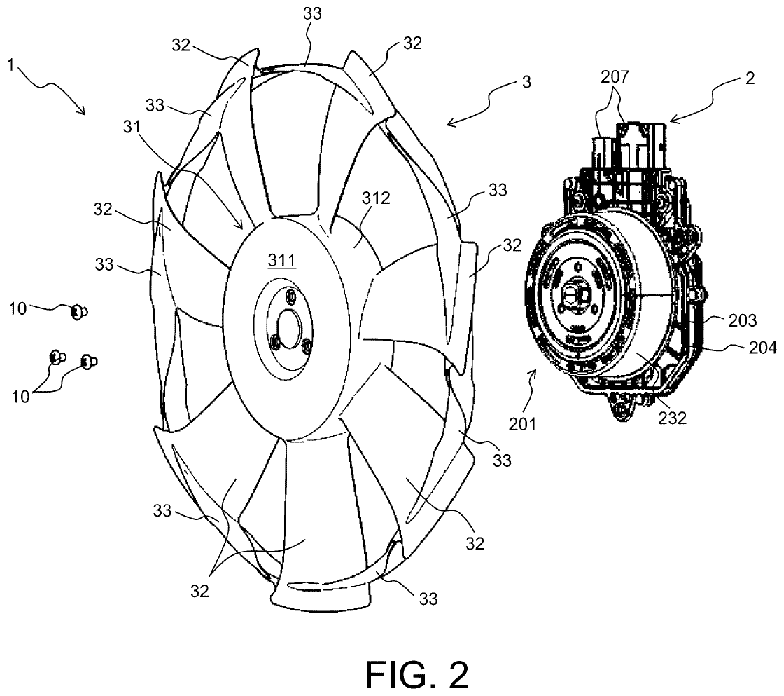

First, the overall configuration of the fan device 1 will be described with reference to FIG. 1 and FIG. 2. FIG. 1 is an external perspective view showing a configuration example of the fan device 1 according to the embodiment. FIG. 2 is an exploded perspective view in the case of disassembling the motor 2 and a fan 3. As shown in FIG. 1 and FIG. 2, the fan device 1 includes the motor 2 that is a drive source, and the fan 3 that is rotationally driven by the motor 2 to generate cooling air.

### Configuration of Fan 3

As shown in FIG. 1 and FIG. 2, the fan 3 has a boss part 31 that rotates integrally with a rotor 23 with an axis of a shaft 21 as the rotation center, multiple (seven in the embodiment) blades 32 that extend radially from the outer periphery of the boss part 31, and multiple (seven in the embodiment) connecting members 33 that connect adjacent blades 32 on the tip side.

Also, the boss part 31 includes a disk-shaped disk part 311 and a cylindrical peripheral wall part 312 that protrudes from the outer edge of the disk part 311 toward the motor 2 and to which the blades 32 are attached. According to the fan 3 being attached to the motor 2, the disk part 311 faces a connecting wall 232c of a rotor yoke 232, and the peripheral wall part 312 surrounds an outer peripheral wall 232a of the rotor yoke 232.

As shown in FIG. 2, the fan 3 is fastened to the rotor yoke 232 by screws 10. In the embodiment, in consideration of the rotational balance of the fan 3, three screws 10 are attached so as to be equally spaced on a circumference centered on the rotation center of the fan 3. Note that it is not necessarily required to use three screws 10 as fastening members for fastening the fan 3 to the motor 2, and there are no particular restrictions on the number of screws 10 or the type of fastening members as long as the fan 3 can be fastened to the motor 2.

### Configuration of Motor 2

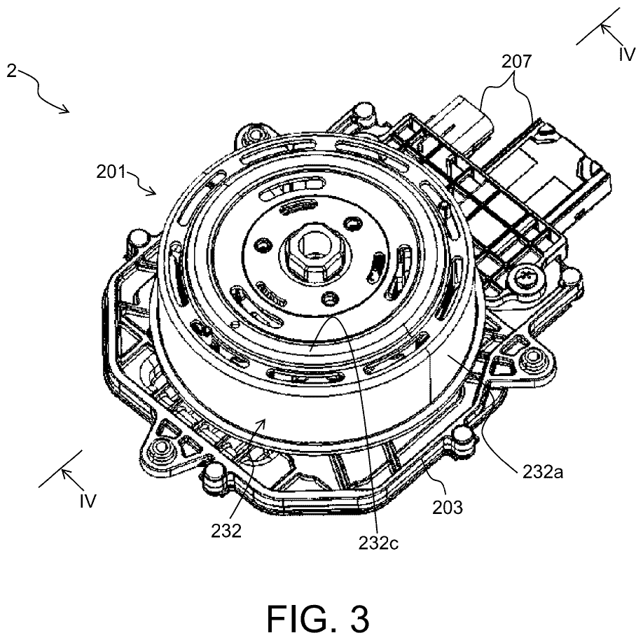

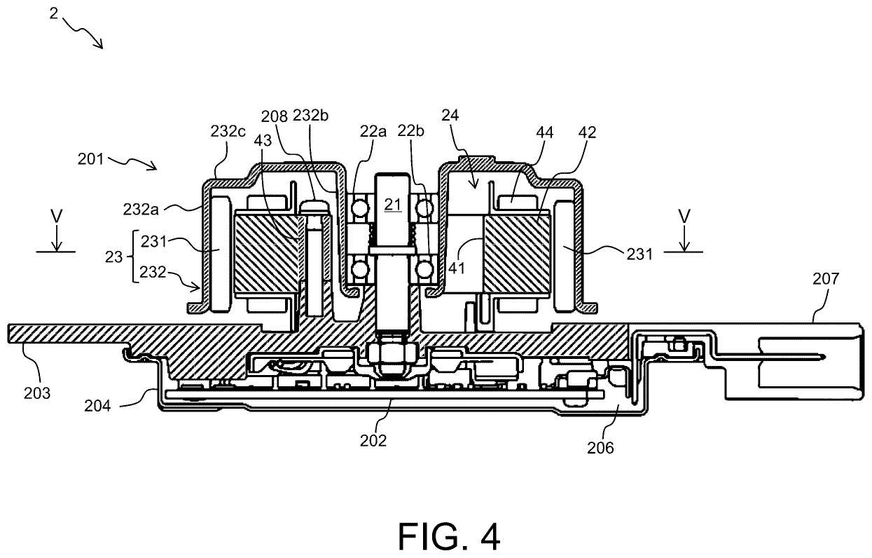

Next, the configuration of the motor 2 will be described with reference to FIG. 3 and FIG. 4. FIG. 3 is an external perspective view of the motor 2 as viewed from the front surface side. FIG. 4 is a cross-sectional view of a brushless motor 201 taken along IV-IV in FIG. 3. As shown in FIG. 4, the motor 2 is a so-called “mechanical and electrical integrated type” electric motor that includes the outer rotor type brushless motor 201 and a driver circuit 202 that controls the brushless motor 201 (more specifically, generation of a magnetic field by a coil 44).

The brushless motor 201 is supported by a plate-shaped motor bracket 203. The brushless motor 201 is disposed on one side (front surface side) of the motor bracket 203 in a thickness direction. Note that in the embodiment, an example of the brushless motor 201 with 10 poles and 12 slots will be described. However, the number of poles and slots of the brushless motor 201 is not limited to the aforementioned example, and may be, for example, 8 poles and 12 slots, or 4 poles and 6 slots (modified example).

A driver bracket 204 is fastened to the other side (back surface side) of the motor bracket 203 in the thickness direction by multiple screws (not shown). As a result, an accommodation space 206 is formed between the motor bracket 203 and the driver bracket 204. The driver circuit 202 is accommodated in the accommodation space 206.

Also, a connector unit 207, which integrates two connectors to which external harnesses are connected, is attached to an end part of the motor bracket 203. The brushless motor 201, the driver circuit 202, and the connector unit 207 are electrically connected to each other via the motor bracket 203.

As shown in FIG. 3 and FIG. 4, the brushless motor 201 includes the shaft 21, bearings 22a and 22b provided on an outer periphery of the shaft 21, the rotor 23 rotatably supported around the axis of the shaft 21 via the bearings 22a and 22b, and a stator 24 that generates a magnetic field for rotating the rotor 23.

The shaft 21 is a fixed shaft fixed to the surface side of the motor bracket 203. In the following description regarding the components of the motor 2, an axial direction of the shaft 21 is simply referred to as the “axial direction,” a radial direction centered on the axis of the shaft 21 is simply referred to as the “radial direction,” and a circumferential direction centered on the axis of the shaft 21 is simply referred to as the “circumferential direction.”

The rotor 23 includes multiple permanent magnets 231 arranged at equal intervals in the circumferential direction so as to surround an outer periphery of the stator 24, and the rotor yoke 232 that covers the stator 24 and the permanent magnets 231 (10 in the embodiment). The rotor yoke 232 is disposed on the surface side of the motor bracket 203 so as to be concentric with the axis of the shaft 21. Also, the rotor yoke 232 is rotatably supported by the shaft 21 via the bearings 22a and 22b. The rotor yoke 232 mainly includes the outer peripheral wall 232a, an inner peripheral wall 232b, and the connecting wall 232c.

The outer peripheral wall 232a presents a cylindrical outer shape. Also, the outer peripheral wall 232a is disposed outside in the radial direction from the stator 24. Furthermore, the outer peripheral wall 232a supports the permanent magnets 231 on an inner peripheral surface. In other words, the permanent magnets 231 are fixed to the inner peripheral surface of the outer peripheral wall 232a, spaced apart in the circumferential direction so as to surround the stator 24.

The inner peripheral wall 232b presents a cylindrical outer shape. Also, the inner peripheral wall 232b is disposed inside in the radial direction from the stator 24. Furthermore, the inner peripheral wall 232b is rotatably supported by the shaft 21 via the bearings 22a and 22b.

The connecting wall 232c presents a disk-shaped outer shape. Also, the connecting wall 232c connects axial end parts of the outer peripheral wall 232a and the inner peripheral wall 232b to each other. More specifically, as shown in FIG. 4, the connecting wall 232c connects the outer peripheral wall 232a and the inner peripheral wall 232b on the other end side in the axial direction of the shaft 21 (that is, on the opposite side from the motor bracket 203).

The stator 24 is accommodated in a space surrounded by the outer peripheral wall 232a, the inner peripheral wall 232b, the connecting wall 232c, and the motor bracket 203. Also, as shown in FIG. 4, the stator 24 is fixed to the surface side of the motor bracket 203 inside in the radial direction from the permanent magnets 231. Furthermore, the stator 24 faces the permanent magnets 231 with a predetermined gap in the radial direction.

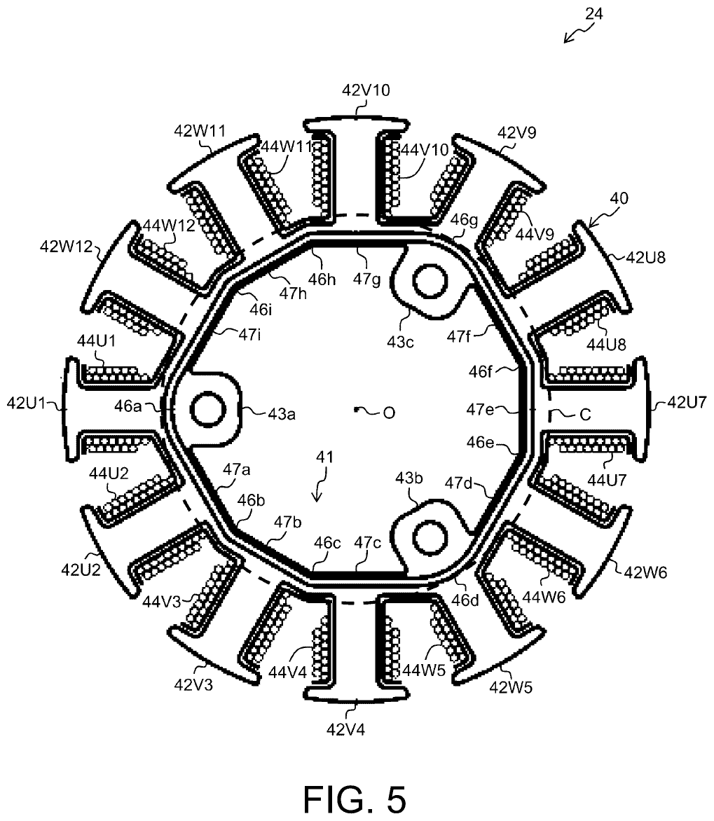

FIG. 5 is a cross-sectional view of the stator 24 taken along V-V in FIG. 4. The stator 24 is composed of a stator core 40 that includes a cylindrical body 41, multiple (12 in the embodiment) teeth 42, and multiple (three in the embodiment) bolt mounting parts 43, and multiple (12 in the embodiment) coils 44.

The stator core 40 is formed by, for example, multiple steel plates stacked in the axial direction. Also, the stator core 40 is configured by covering the stacked steel plates with an insulating insulator. The coil 44 is wound around the teeth 42 from above the insulator. Then, the stator 24 generates a magnetic field for rotating the rotor 23 in response to a current flowing through the coil 44.

The cylindrical body 41 according to the embodiment has a nonagonal cross-section perpendicular to an extension direction of the shaft 21 and presents a cylindrical outer shape extending in the extension direction of the shaft 21. The cylindrical body 41 is composed of nine flat surfaces 47a to 47i and nine corner parts 46a to 46i. The flat surfaces 47a to 47i are arranged in the circumferential direction so as to surround the shaft 21 and the bearings 22a and 22b. The corner parts 46a to 46i are located at boundaries between the flat surfaces 47a to 47i that are adjacent in the circumferential direction. Note that the corner parts 46a to 46i may be chamfered. The cylindrical body 41 has an inner surface and an outer surface.

On the opposite side of the corner parts 46a, 46d, and 46g across a center O of the shaft 21, the flat surfaces 47e, 47h, and 47b are formed. Also, the flat surfaces 47a and 47f, the flat surfaces 47c and 47g, and the flat surfaces 47d and 47i are located on opposite sides across the center O of the shaft 21 and are disposed parallel to each other.

Among the nine corner parts 46a to 46i, the three corner parts 46a, 46d, and 46g disposed at equal intervals (120° intervals) are disposed at positions farther from the center O of the shaft 21 than the other six corner parts 46b, 46c, 46e, 46f, 46h, and 46i. All the flat surfaces 47a to 47i are disposed inside a virtual circle C of the center O (shown by a broken line in FIG. 5) passing through the corner parts 46a, 46d, and 46g.

Multiple teeth 42 protrude radially from the outer surface of the cylindrical body 41. In other words, the teeth 42 protrude radially outward from positions spaced apart in the circumferential direction on the outer surface of the cylindrical body 41. Furthermore, in other words, the teeth 42 include teeth 42U1, 42W5, and 42V9 that protrude radially outward from the positions of the corner parts 46a, 46d, and 46g, and teeth 42U2, 42V3, 42V4, 42W6, 42U7, 42U8, 42V10, 42W11, and 42W12 that protrude radially outward from the positions of the flat surfaces 47a to 47i.

The teeth 42U1, 42W5, and 42V9 protrude in the direction of straight lines passing through the center O of the shaft 21 and the corner parts 46a, 46d, and 46g (in other words, in the direction of normals to the virtual circle C at the positions of the corner parts 46a, 46d, and 46g). Also, the teeth 42U2, 42V3, 42V4, 42W6, 42U7, 42U8, 42V10, 42W11, and 42W12 protrude from the circumferential centers of the flat surfaces 47a to 47i in directions perpendicular to the flat surfaces 47a to 47i.

The protruding ends of all the teeth 42 are at the same distance from the center O. On the other hand, since the flat surfaces 47a to 47i are located inside in the radial direction from the corner parts 46a, 46d, and 46g, the protrusion amount (length in the radial direction) of the teeth 42U2, 42V3, 42V4, 42W6, 42U7, 42U8, 42V10, 42W11, and 42W12 is greater than the protrusion amount of the teeth 42U1, 42W5, and 42V9. That is, the number of turns of the coil 44 that can be wound around the teeth 42U2, 42V3, 42V4, 42W6, 42U7, 42U8, 42V10, 42W11, and 42W12 is greater than that of the teeth 42U1, 42W5, and 42V9.

Bolt mounting parts 43a, 43b, and 43c are provided on the inner surfaces of the corner parts 46a, 46d, and 46g. More specifically, the bolt mounting parts 43a, 43b, and 43c protrude radially inward from the inner surfaces of the corner parts 46a, 46d, and 46g. Also, through holes extending in the extension direction of the shaft 21 are formed in the bolt mounting parts 43a, 43b, and 43c.

Then, bolts 208 (see FIG. 4) for fixing the stator 24 to the motor bracket 203 are inserted through the through holes of the bolt mounting parts 43a, 43b, and 43c. More specifically, the bolts 208 that have passed through the through holes of the bolt mounting parts 43a, 43b, and 43c are screwed into bolt holes formed on the surface of the motor bracket 203. In this way, the stator 24 is fixed to the motor bracket 203.

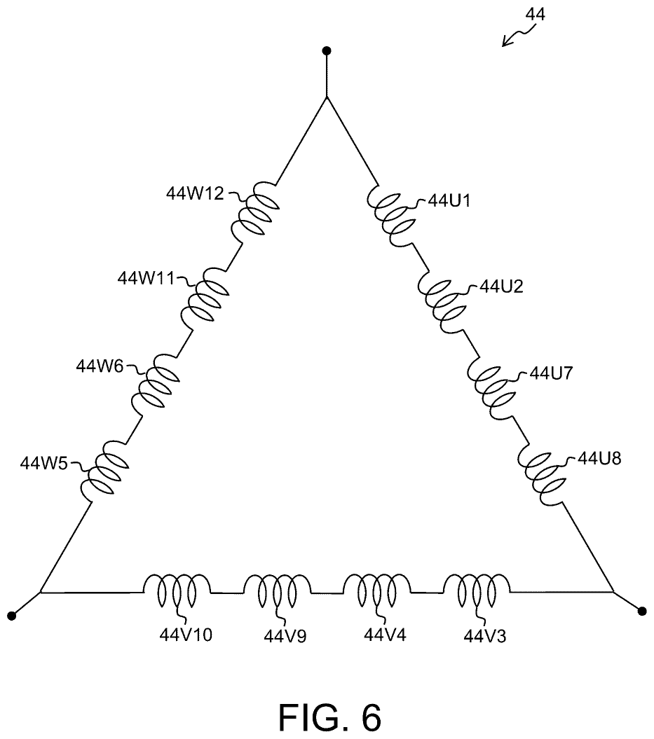

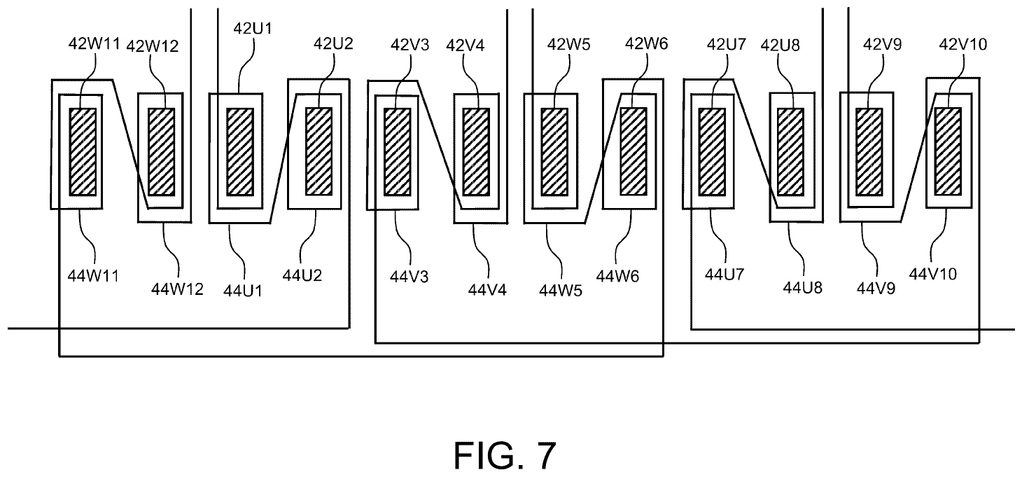

FIG. 6 is a diagram showing the connection state (delta connection) of the coil 44. FIG. 7 is a winding development diagram of the stator 24. As shown in FIG. 6 and FIG. 7, the coil 44 includes coils 44U1, 44U2, 44U7, and 44U8 through which a U-phase current flows, coils 44V3, 44V4, 44V9, and 44V10 through which a V-phase current flows, and coils 44W5, 44W6, 44W11, and 44W12 through which a W-phase current flows.

The coils 44U1, 44U2, 44U7, and 44U8 are wound around the teeth 42U1, 42U2, 42U7, and 42U8. Also, the coils 44U1, 44U2, 44U7, and 44U8 are connected in series. That is, one winding wire is wound in the order of the teeth 42U1, 42U2, 42U7, and 42U8 as the coils 44U1, 44U2, 44U7, and 44U8.

The coils 44V3, 44V4, 44V9, and 44V10 are wound around the teeth 42V3, 42V4, 42V9, and 42V10. Also, the coils 44V3, 44V4, 44V9, and 44V10 are connected in series. That is, one winding wire is wound in the order of the teeth 42V3, 42V4, 42V9, and 42V10 as the coils 44V3, 44V4, 44V9, and 44V10.

The coils 44W5, 44W6, 44W11, and 44W12 are wound around the teeth 42W5, 42W6, 42W11, and 42W12. Also, the coils 44W5, 44W6, 44W11, and 44W12 are connected in series. That is, one winding wire is wound in the order of the teeth 42W5, 42W6, 42W11, and 42W12 as the coils 44W5, 44W6, 44W11, and 44W12.

One end of the winding wire constituting the coils 44U1, 44U2, 44U7, and 44U8 and one end of the winding wire constituting the coils 44V3, 44V4, 44V9, and 44V10 are connected. Also, the other end of the winding wire constituting the coils 44V3, 44V4, 44V9, and 44V10 and one end of the winding wire constituting the coils 44W5, 44W6, 44W11, and 44W12 are connected. Furthermore, the other end of the winding wire constituting the coils 44W5, 44W6, 44W11, and 44W12 and the other end of the winding wire constituting the coils 44U1, 44U2, 44U7, and 44U8 are connected. That is, the coils 44U1, 44U2, 44U7, and 44U8, the coils 44V3, 44V4, 44V9, and 44V10, and the coils 44W5, 44W6, 44W11, and 44W12 are delta connected.

The U-phase coil 44U1 is wound around the teeth 42U1 formed at the corner part 46a at which the bolt mounting part 43a is provided. The coil 44U2 is wound around the teeth 42U2 formed on the flat surface 47a adjacent to one side in the circumferential direction (for example, counterclockwise) with respect to the corner part 46a. The coil 44U7 is wound around the teeth 42U7 formed on the flat surface 47e on the opposite side of the corner part 46a across the center O of the shaft 21. The coil 44U8 is wound around the teeth 42U8 formed on the flat surface 47f adjacent to one side in the circumferential direction with respect to the flat surface 47e.

A first number of turns T1 of the coils 44U1 and 44U8 wound around the teeth 42U1 and 42U8 is set to be less than a second number of turns T2 of the coils 44U2 and 44U7 wound around the teeth 42U2 and 42U7 (T1<T2). The teeth 42U1 and 42U8 are an example of first teeth, and the teeth 42U2 and 42U7 are an example of second teeth.

That is, the coil 44U1 with the first number of turns T1 is wound around the tooth 42U1 formed at the corner part 46a at which the bolt mounting part 43a is provided. Also, the coil 44U2 with the second number of turns T2 is wound around the tooth 42U2 adjacent to one side in the circumferential direction of the tooth 42U1. Also, the coil 44U7 with the second number of turns T2 is wound around the tooth 42U7 on the opposite side of the teeth 42U1 across the center O of the shaft 21. Furthermore, the coil 44U8 with the first number of turns T1 is wound around the tooth 42U8 adjacent to one side in the circumferential direction of the teeth 42U7.

The V-phase coil 44V9 is wound around the tooth 42V9 formed at the corner part 46g at which the bolt mounting part 43c is provided. The coil 44V10 is wound around the tooth 42V10 formed on the flat surface 47g adjacent to one side in the circumferential direction with respect to the corner part 46g. The coil 44V3 is wound around the tooth 42V3 formed on the flat surface 47b on the opposite side of the corner part 46g across the center O of the shaft 21. The coil 44V4 is wound around the tooth 42V4 formed on the flat surface 47c adjacent to one side in the circumferential direction with respect to the flat surface 47b.

The first number of turns T1 of the coils 44V4 and 44V9 wound around the teeth 42V4 and 42V9 is set to be less than the second number of turns T2 of the coils 44V3 and 44V10 wound around the teeth 42V3 and 42V10. The teeth 42V4 and 42V9 are an example of the first teeth, and the teeth 42V3 and 42V10 are an example of the second teeth. That is, the layout of the V-phase coils 44V3, 44V4, 44V9, and 44V10 corresponds to the layout of the U-phase coils 44U1, 44U2, 44U7, and 44U8 shifted by 120° to the other side (clockwise) in the circumferential direction.

The W-phase coil 44W5 is wound around the tooth 42W5 formed at the corner part 46d at which the bolt mounting part 43b is provided. The coil 44W6 is wound around the tooth 42W6 formed on the flat surface 47d adjacent to one side in the circumferential direction with respect to the corner part 46d. The coil 44W11 is wound around the tooth 42W11 formed on the flat surface 47h on the opposite side of the corner part 46d across the center O of the shaft 21. The coil 44W12 is wound around the tooth 42W12 formed on the flat surface 47i adjacent to one side in the circumferential direction with respect to the flat surface 47h.

The first number of turns T1 of the coils 44W5 and 44W12 wound around the teeth 42W5 and 42W12 is set to be less than the second number of turns T2 of the coils 44W6 and 44W11 wound around the teeth 42W6 and 42W11. The teeth 42W5 and 42W12 are an example of the first teeth, and the teeth 42W6 and 42W11 are an example of the second teeth. That is, the layout of the W-phase coils 44W5, 44W6, 44W11, and 44W12 corresponds to the layout of the U-phase coils 44U1, 44U2, 44U7, and 44U8 shifted by 120° to one side (counterclockwise) in the circumferential direction.

In this way, the teeth 42U1, 42W5, and 42V9 formed at the corner parts 46a, 46d, and 46g at which the bolt mounting parts 43a, 43b, and 43c are provided have the coils 44U1, 44W5, and 44V9 of different phases wound therearound. Also, the teeth 42U1 and 42U7, teeth 42U2 and 42U8, teeth 42V3 and 42V9, teeth 42V4 and 42V10, teeth 42W5 and 42W11, and teeth 42W6 and 42W12 located on opposite sides across the center O of the shaft 21 have coils of the same phase wound therearound, and the number of turns of the coils differ. Furthermore, the total number of turns of the coils wound around the two teeth located on opposite sides across the center O of the shaft 21 is the same at T1+T2.

### Operational Effects of Embodiment

In the brushless motor 201 according to the above embodiment, assuming that the size of the virtual circle C in FIG. 5 is made to match the contour line of the cylindrical body having a cylindrical shape in Patent Literature 1. In this way, the pitch of the bolt mounting parts 43a, 43b, and 43c may be made the same as conventional ones. On the other hand, in the case of making the radial size of the brushless motor 201 smaller than the motor of Patent Literature 1, the number of turns of the coils 44U1, 44W5, and 44V9 of the teeth 42U1, 42W5, and 42V9 formed at the corner parts 46a, 46d, and 46g decreases. Therefore, by disposing the flat surfaces 47e, 47h, and 47b inside the virtual circle C, the protrusion amount of the teeth 42U7, 42W11, and 42V3 can be made greater than the protrusion amount of Patent Literature 1, so the number of turns of the coils 44U7, 44W11, and 44V3 can be increased.

Here, assuming that the number of the permanent magnets 231, effective magnetic flux, and magnitude of the current flowing through the coil 44 are the same, the output of the brushless motor 201 is determined by the total number of turns of the coil 44. Therefore, with respect to a number of turns T0 (for example, 16 turns) of each of the coils in Patent Literature 1, the first number of turns T1 (for example, 14 turns) of the coils 44U1, 44W5, and 44V9 is reduced, and the second number of turns T2 (for example, 18 turns) of the coils 44U7, 44W11, and 44V3 is increased. Also, T0=(T1+T2)/2. In this way, the brushless motor 201 may be miniaturized without reducing motor output.

On the other hand, in the case of making the radial size of the brushless motor 201 the same as the motor of Patent Literature 1, the number of turns of the coils 44U1, 44W5, and 44V9 becomes the same as Patent Literature 1, and the number of turns of the coils 44U7, 44W11, and 44V3 can be made greater than Patent Literature 1. As a result, motor output can be increased without increasing the size of the brushless motor 201.

Also, according to the above embodiment, not only the number of turns of the coils 44U1, 44W5, and 44V9 at the positions of the corner parts 46a, 46d, and 46g is reduced, but also the number of turns of the coils 44U8, 44V4, and 44W12 is reduced, and instead the number of turns of the coils 44U2, 44V10, and 44W6 is increased. In this way, the sum (T1+T2) of the number of turns of two coils disposed on opposite sides across the center O of the shaft 21 may be made constant over the entire circumference, so output variation due to rotation angle can be reduced.

However, from the perspective of increasing motor output, the number of turns of the coils 44U1, 44W5, and 44V9 at the positions of the corner parts 46a, 46d, and 46g may be set as the first number of turns T1, and the number of turns of all the coils 44U2, 44V3, 44V4, 44W6, 44U7, 44U8, 44V10, 44W11, and 44W12 at the positions of the flat surfaces 47a to 47i may be set as the second number of turns T2.

Also, according to the above embodiment, by making the teeth 42U2, 42V3, 42V4, 42W6, 42U7, 42U8, 42V10, 42W11, and 42W12 perpendicular to the flat surfaces 47a to 47i, it becomes easier to increase the number of turns of the coils 44U2, 44V3, 44V4, 44W6, 44U7, 44U8, 44V10, 44W11, and 44W12 compared to making the teeth protrude from a cylindrical surface as in Patent Literature 1.

### Modified Example

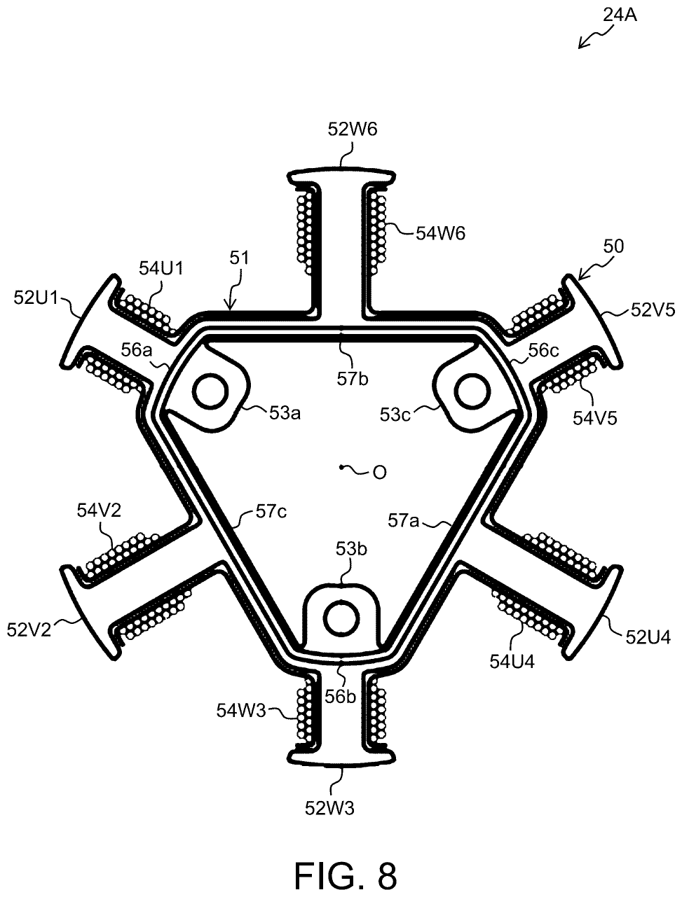

FIG. 8 is a cross-sectional view of a stator 24A according to a modified example. Note that detailed description of common points with the above embodiment is omitted, and the description focuses on differences. The stator 24A according to the modified example includes a stator core 50 that includes a cylindrical body 51, multiple (six in the embodiment) teeth 52, and multiple (three in the embodiment) bolt mounting parts 53, and multiple (six in the embodiment) coils 54.

The cylindrical body 51 according to the modified example has a triangular cross-section perpendicular to the extension direction of the shaft 21 and presents a cylindrical outer shape extending in the extension direction of the shaft 21. The cylindrical body 51 is composed of three flat surfaces 57a to 57c and three corner parts 56a to 56c. The flat surfaces 57a to 57c are arranged in the circumferential direction so as to surround the shaft 21 and the bearings 22a and 22b. The corner parts 56a to 56c are located at boundaries between the flat surfaces 57a to 57c that are adjacent in the circumferential direction. Note that the corner parts 56a to 56c may be chamfered. The cylindrical body 51 has an inner surface and an outer surface. Furthermore, the flat surfaces 57a, 57b, and 57c are formed on the opposite side from the corner parts 56a, 56b, and 56c across the center O of the shaft 21.

The teeth 52 protrude radially from the outer surface of the cylindrical body 51. In other words, the teeth 52 protrude radially outward from positions spaced apart in the circumferential direction on the outer surface of the cylindrical body 51. In further other words, the teeth 52 include teeth 52U1, 52W3, and 52V5 that protrude radially outward from the positions of the corner parts 56a, 56b, and 56c, and teeth 52U4, 52W6, and 52V2 that protrude radially outward from the positions of the flat surfaces 57a to 57c. The teeth 52U1, 52W3, and 52V5 protrude in the direction of straight lines passing through the center O of the shaft 21 and the corner parts 56a, 56b, and 56c. Also, the teeth 52U4, 52W6 , and 52V2 protrude from the circumferential center of the flat surfaces 57a to 57c in a direction perpendicular to the flat surfaces 57a to 57c.

Bolt mounting parts 53a, 53b, and 53c are provided on the inner surfaces of the corner parts 56a, 56b, and 56c. Then, bolts for fixing the stator 24A to the motor bracket 203 are inserted through the bolt mounting parts 53a, 53b, and 53c. In this way, the stator 24A is fixed to the motor bracket 203.

The U-phase coil 54U1 is wound around the tooth 52U1 formed at the corner part 56a at which the bolt mounting part 53a is provided. The coil 54U4 is wound around the tooth 52U4 formed at the flat surface 57a on the opposite side from the corner part 56a across the center O of the shaft 21. The first number of turns T1 of the coil 54U1 wound around the tooth 52U1 is set to be less than the second number of turns T2 of the coil 54U4 wound around the tooth 52U4. The tooth 52U1 is an example of the first teeth, and the tooth 52U4 is an example of the second teeth.

The W-phase coil 54W3 is wound around the tooth 52W3 formed at the corner part 56b at which the bolt mounting part 53b is provided. The coil 54W6 is wound around the tooth 52W6 formed at the flat surface 57b on the opposite side from the corner part 56b across the center O of the shaft 21. The first number of turns T1 of the coil 54W3 wound around the tooth 52W3 is set to be less than the second number of turns T2 of the coil 54W6 wound around the tooth 52W6. The tooth 52W3 is an example of the first teeth, and the tooth 52W6 is an example of the second teeth.

The V-phase coil 54V5 is wound around the tooth 52V5 formed at the corner part 56c at which the bolt mounting part 53c is provided. The coil 54V2 is wound around the tooth 52V2 formed at the flat surface 57c on the opposite side from the corner part 56c across the center O of the shaft 21. The first number of turns T1 of the coil 54V5 wound around the tooth 52V5 is set to be less than the second number of turns T2 of the coil 54V2 wound around the tooth 52V2. The tooth 52V5 is an example of the first teeth, and the tooth 52V2 is an example of the second teeth.

In this way, the teeth 52U1, 52W3, and 52V5 formed at the corner parts 56a, 56b, and 56c at which the bolt mounting parts 53a, 53b, and 53c are provided have the coils 54U1, 54W3, and 54V5 of different phases wound therearound. Also, the teeth 52U1, 52U4, the teeth 52V2 and 52V5, and the teeth 52W3 and 52W6 on the opposite sides across the center O of the shaft 21 have coils of the same phase wound therearound, and the number of turns of the coils differ. Furthermore, the total number of turns of the coils wound around the two teeth located on opposite sides across the center O of the shaft 21 is the same at T1+T2.

That is, in the stator 24A according to the modified example, the first teeth 52U1, 52W3, and 52V5, the second teeth 52V2, 52U4, and 52W6, and the bolt mounting parts 53a, 53b, and 53c are each provided at three locations. In this way, the disclosure is applicable to, for example, a 4-pole 6-slot motor.

The embodiments of the disclosure have been described above. In addition, the disclosure is not limited to the above-described embodiments, and includes various modified examples. For example, the above-described embodiments have been described in detail in order to describe the disclosure in an easy-to-understand manner, and are not necessarily limited to those having all the configurations described. Further, a part of the configuration of the embodiment may be replaced with the configuration of another embodiment, and the configuration of another embodiment may also be added to the configuration of the embodiment. Furthermore, a part of the configuration of the embodiment may be added to, deleted from, or replaced with another configuration.

What is claimed is:

1. A motor, comprising:
a motor bracket;
a shaft, fixed to the motor bracket;
a rotor, rotatably supported by the shaft; and
a stator, fixed to the motor bracket inside the rotor and configured to generate a magnetic field for rotating the rotor, and
the stator comprising:
a cylindrical body, comprising a plurality of flat surfaces arranged in a circumferential direction so as to surround the shaft, and corner parts located at boundaries between the adjacent flat surfaces;
a plurality of first teeth, protruding outward from an outer surface of the cylindrical body and having coils wound thereon, and a plurality of second teeth having a greater number of coil turns than the first teeth; and
a plurality of bolt mounting parts, provided on inner surfaces of the corner parts, into which bolts for fixing the stator to the motor bracket are inserted,
the plurality of flat surfaces being located inside a virtual circle passing through the plurality of corner parts at which the bolt mounting parts are provided,
the first teeth being formed on outer surfaces of the corner parts at which the bolt mounting parts are provided, and
the second teeth being formed on outer surfaces of the flat surfaces on opposite sides of the corner parts at which the bolt mounting parts are provided across the shaft.

2. The motor according to claim 1, wherein
the cylindrical body comprises nine locations of the flat surfaces and nine locations of the corner parts,
the bolt mounting parts are provided at three locations among the nine locations of the corner parts at equal intervals, and
the first teeth and the second teeth are formed at the three locations of the corner parts at which the bolt mounting parts are provided and at the nine locations of the flat surfaces.

3. The motor according to claim 2, wherein
the second teeth are also formed on the flat surfaces adjacent to one side in the circumferential direction with respect to the corner parts at which the bolt mounting parts are provided, and
the first teeth are also formed on the flat surfaces adjacent to one side in the circumferential direction with respect to the flat surfaces on the opposite sides of the corner parts at which the bolt mounting parts are provided across the shaft.

4. The motor according to claim 1, wherein
the first teeth, the second teeth, and the bolt mounting parts are each provided at three locations.

5. The motor according to claim 1, wherein
the second teeth protrude in a direction perpendicular to the flat surfaces.

6. The motor according to claim 1, further comprising:
a bearing, disposed inside the cylindrical body and configured to rotatably support the rotor with respect to the shaft.
